(19) United States
(12) Patent Application Publication
(10) Pub. No.: US 2026/0246389 A1
(43) Pub. Date: Aug. 20, 2026

(54) AC/DC CONVERSION CIRCUIT

(71) Applicant: ROHM Co., Ltd., Kyoto (JP)

(72) Inventors: Riku Tatetsu, Kyoto (JP); Kohei Sebata, Kyoto (JP); Toshiyuki Zaitsu, Kyoto (JP); Shu Makino, Kyoto (JP); Shuichiro Motoori, Kyoto (JP)

(73) Assignee: ROHM Co., Ltd., Kyoto (JP)

(21) Appl. No.: 19/538,904

(22) Filed: Feb. 12, 2026

(30) Foreign Application Priority Data
Feb. 17, 2025 (JP) 2025-023724
Oct. 20, 2025 (JP) 2025-176787

(51) Int. Cl. H02M 3/335; H02M 1/32; H02M 3/156; H02M 3/158

(52) U.S. Cl. CPC H02M 3/33507; H02M 1/32; H02M 3/156; H02M 3/158

(57) ABSTRACT

The AC/DC conversion circuit includes a rectifier circuit that performs full-wave rectification of an input AC voltage and outputs a rectified voltage; a capacitor that smooths the rectified voltage; a switch that turns on and off according to a drive signal, connects the rectifier circuit and the capacitor by entering an on state, and disconnects the rectifier circuit and the capacitor by entering an off state; a driver that outputs the drive signal; and a control circuit that controls the driver. The control circuit controls the driver so that the switch transitions to an on state in response to a level of the rectified voltage becoming lower than a level of a predetermined clamp voltage, and the switch transitions to an off state before the level of the rectified voltage becomes higher than the level of the clamp voltage.

### CROSS-REFERENCE TO RELATED APPLICATION

This application claims the priority benefits of Japanese application serial no. 2025-023724, filed on February 17, 2025, and Japanese application serial no. 2025-176787, filed on October 20, 2025. The entirety of the above-mentioned patent application is hereby incorporated by reference herein and made a part of this specification.

### Technical Field

The disclosure relates to an AC/DC conversion circuit.

### Background Art

The following technology is known as technology relating to a voltage clamper type AC/DC conversion circuit. Non-Patent Document 1 describes an input active clamp circuit in which a FET switch is provided between a diode bridge and an input capacitor.

Patent Document 1 describes an overvoltage protection circuit connected between a rectifier circuit and a load having an input capacitor. The overvoltage protection circuit includes a semiconductor switch that is connected between the rectifier circuit and the load, and a control circuit that controls on or off of the semiconductor switch. The control circuit turns off the semiconductor switch in response to the rectified voltage exceeding a predetermined value, while generating a control voltage for turning on the semiconductor switch during a period in which the potential difference across both ends of the semiconductor switch is zero or a predetermined minute value. The overvoltage protection circuit includes a current change circuit that gradually changes the current flowing through the semiconductor switch, so that the conducted interference voltage in the output voltage output from the overvoltage protection circuit becomes equal to or less than a predetermined value in the case of turning off the semiconductor switch and/or turning on the semiconductor switch.

### Related Art Documents

### Patent Document

Patent Document 1 Japanese Patent Application Laid-Open No. 2019-30179

### Non-Patent Document

Non-Patent Document 1 HCA-23-023 Optimization Study of Input Active Clamp Circuit for Low Power ACDC Converter

### BRIEF DESCRIPTION OF THE DRAWINGS

FIG. 1 is a diagram showing an example of the configuration of the AC/DC conversion circuit according to an embodiment of the disclosure.

FIG. 2A is a circuit block diagram showing an example of the configuration of the control circuit according to an embodiment of the disclosure.

FIG. 2B is a circuit block diagram showing another example of the configuration of the control circuit according to an embodiment of the disclosure.

FIG. 2C is a circuit block diagram showing another example of the configuration of the control circuit according to an embodiment of the disclosure.

FIG. 2D is a circuit block diagram showing another example of the configuration of the control circuit according to an embodiment of the disclosure.

FIG. 3 is a timing chart showing an example of operation of the AC/DC conversion circuit according to a comparative example.

FIG. 4A shows the measured waveforms in the case of performing switch control according to a comparative example.

FIG. 4B is a diagram showing analysis results of the frequency spectrum of the drain-source voltage in the case of performing switch control according to a comparative example.

FIG. 5 is a timing chart showing an example of operation of the AC/DC conversion circuit according to an embodiment of the disclosure.

FIG. 6 is a timing chart showing an example of operation of the AC/DC conversion circuit according to another embodiment of the disclosure.

FIG. 7 is a diagram showing an example of the configuration of the AC/DC conversion circuit according to another embodiment of the disclosure.

FIG. 8A is a circuit block diagram showing an example of the configuration of the control circuit according to an embodiment of the disclosure.

FIG. 8B is a circuit block diagram showing an example of the configuration of the control circuit according to an embodiment of the disclosure.

FIG. 9 is a timing chart showing an example of operation of the AC/DC conversion circuit according to another embodiment of the disclosure.

FIG. 10A shows the measured waveforms in the case of performing switch control according to another embodiment of the disclosure.

FIG. 10B is a diagram showing analysis results of the frequency spectrum of the drain-source voltage in the case of performing switch control according to another embodiment of the disclosure.

FIG. 11 is a diagram showing an example of the configuration of the AC/DC conversion circuit according to a modification example.

FIG. 12 is a timing chart showing an example of operation of the AC/DC conversion circuit according to another embodiment of the disclosure.

FIG. 13 is a timing chart showing an example of operation of the AC/DC conversion circuit according to another embodiment of the disclosure.

FIG. 14 is a diagram showing an example of the configuration of another AC/DC conversion circuit of the disclosure.

FIG. 15 is a diagram showing an example of the configuration of another AC/DC conversion circuit of the disclosure.

FIG. 16 is a diagram showing an example of the operation waveform of the AC/DC conversion circuit according to another embodiment of the disclosure.

FIG. 17 is a diagram showing an example of the operation waveform of the AC/DC conversion circuit according to another embodiment of the disclosure.

### DETAILED DESCRIPTION

Hereinafter, embodiments of the disclosure will be described with reference to the drawings. In the drawings, substantially identical or equivalent components or parts are given the same reference numerals.

### First Embodiment

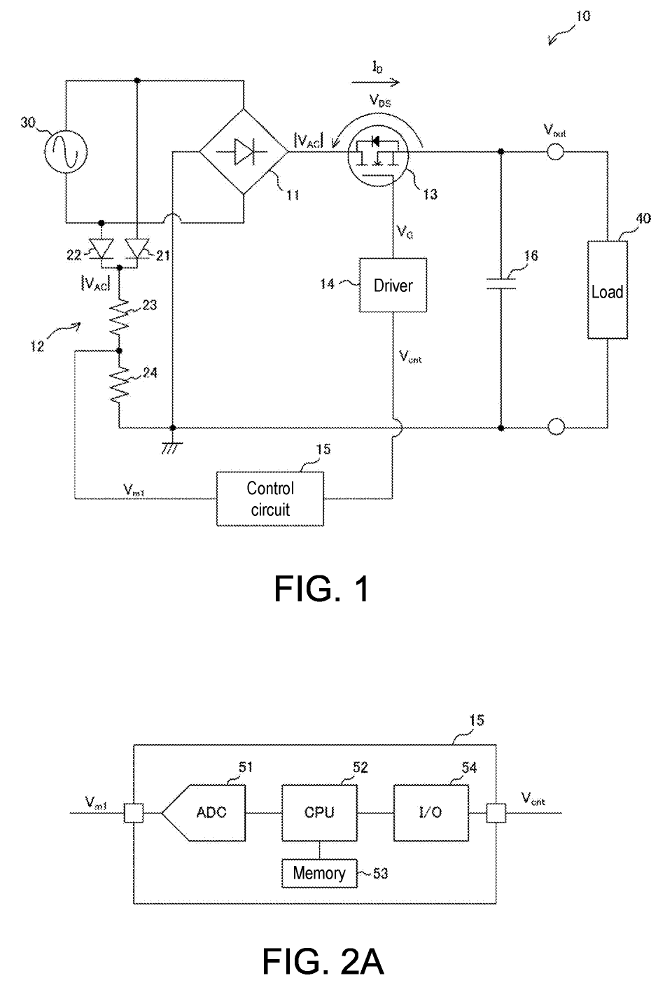

FIG. 1 is a diagram showing an example of the configuration of an AC/DC conversion circuit 10 according to an embodiment of the disclosure. The AC/DC conversion circuit 10 is a voltage clamper type AC/DC conversion circuit and has a function of lowering the level of a DC voltage, which is obtained by full-wave rectification and smoothing of an AC voltage, to the level of a predetermined clamp voltage V_{clamp} and outputting the same. The AC/DC conversion circuit 10 includes a rectifier circuit 11, a rectified voltage monitor circuit 12, a switch 13, a driver 14, a control circuit 15, and a capacitor 16.

The rectifier circuit 11 performs full-wave rectification of an AC voltage supplied from an AC power supply 30 and outputs a rectified voltage |V_{AC}|. The rectifier circuit 11 is configured by, for example, a diode bridge circuit that includes multiple diodes. One of the output terminals of the rectifier circuit 11 is connected to one end of the switch 13, and the other output terminal is connected to a ground line.

The switch 13 is configured by an n-channel type MOSFET (Metal-Oxide-Semiconductor Field-Effect Transistor). The MOSFET has a drain connected to the rectifier circuit 11, a source connected to a load 40, and a gate connected to the driver 14. The switch 13 turns on and off according to a drive signal V_{G} supplied from the driver 14. The rectifier circuit 11 and the capacitor 16 are connected in response to the switch 13 entering an on state. The rectifier circuit 11 and the capacitor 16 are disconnected in response to the switch 13 entering an off state.

The capacitor 16 has one end connected to the source of the MOSFET that constitutes the switch 13, and the other end connected to the ground line. The capacitor 16 smooths the rectified voltage |V_{AC}| output from the rectifier circuit 11. The smoothed rectified voltage is supplied to the load 40 as a DC output voltage Vₒᵤₜ. The level of the output voltage Vₒᵤₜ is limited by the switch 13 intermittently entering an on state.

The driver 14 outputs the drive signal V_{G} for driving the switch 13 based on a control signal V_{cnt} supplied from the control circuit 15. The drive signal V_{G} is input to the gate of the MOSFET that constitutes the switch 13.

The rectified voltage monitor circuit 12 is a circuit for monitoring the rectified voltage |V_{AC}| output from the rectifier circuit 11 in the control circuit 15. The rectified voltage monitor circuit 12 includes diodes 21 and 22 and resistance elements 23 and 24. An anode of the diode 21 is connected to one of the input lines of the AC voltage, and an anode of the diode 22 is connected to the other input line of the AC voltage. The cathodes of the diodes 21 and 22 are connected to one end of the resistance element 23. The other end of the resistance element 23 is connected to one end of the resistance element 24, and the other end of the resistance element 24 is connected to the ground line. The rectified voltage monitor circuit 12 outputs a monitor voltage Vₘ₁ obtained by dividing the same voltage as the rectified voltage |V_{AC}| output from the rectifier circuit 11 by the resistance elements 23 and 24 from a connection point of the resistance element 23 and the resistance element 24. The monitor voltage Vₘ₁ is supplied to the control circuit 15.

The control circuit 15 outputs the control signal V_{cnt} for controlling the driver 14 based on the monitor voltage Vₘ₁. More specifically, the control circuit 15 controls the driver 14 so that the switch 13 transitions to an on state (turns on) in response to the level of the rectified voltage |V_{AC}| becoming lower than the level of the clamp voltage V_{clamp}, and the switch 13 transitions to an off state (turns off) before the level of the rectified voltage |V_{AC}| becomes higher than the level of the clamp voltage V_{clamp}. The clamp voltage V_{clamp} is a voltage that defines the level of the output voltage Vₒᵤₜ and is set in advance.

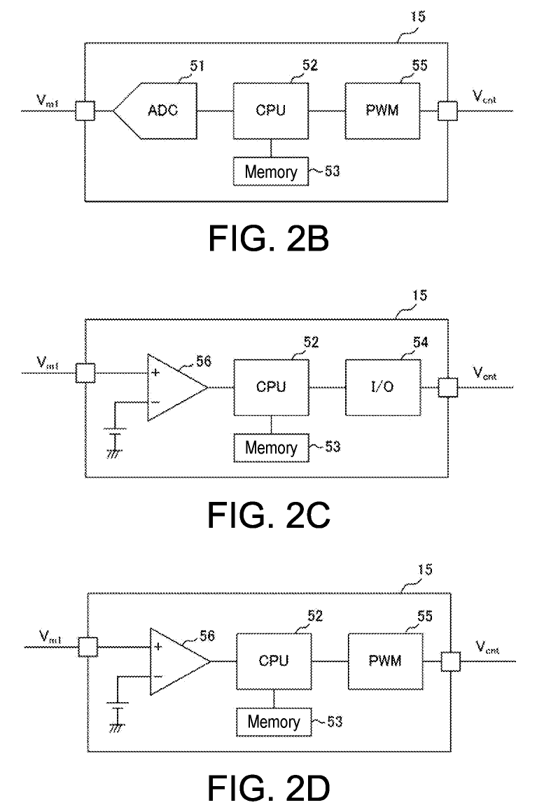

FIG. 2A is a circuit block diagram showing an example of the configuration of the control circuit 15. The control circuit 15 includes an analog-to-digital converter (ADC) 51, a CPU (Central Processing Unit) 52, a memory 53, and an I/O circuit 54. The analog-to-digital converter 51 converts the monitor voltage Vₘ₁ supplied from the rectified voltage monitor circuit 12 into a digital value. The memory 53 is a work memory for the CPU 52 to execute processing according to a program.

The CPU 52 monitors the level of the rectified voltage |V_{AC}| by the monitor voltage Vₘ₁ converted into a digital value. The CPU 52 determines an on timing and an off timing of the switch 13 based on the monitor voltage Vₘ₁. The CPU 52 provides a command specifying the on timing and the off timing of the switch 13 to the I/O circuit 54. The I/O circuit 54 outputs the control signal V_{cnt} that is a pulse signal based on the command from the CPU 52.

FIG. 2B is a circuit block diagram showing another example of the configuration of the control circuit 15. The control circuit 15 may include a PWM circuit 55 in place of the I/O circuit 54 shown in FIG. 2A. The PWM circuit 55 outputs the control signal V_{cnt} that is a pulse signal having a predetermined pulse width based on the command from the CPU 52.

FIG. 2C is a circuit block diagram showing another example of the configuration of the control circuit 15. The control circuit 15 may include a comparator 56 in place of the analog-to-digital converter 51 shown in FIG. 2A. The comparator 56 outputs a comparison result between the level of the monitor voltage Vₘ₁ and the level of a reference voltage V_{ref}. The level of the reference voltage V_{ref} is set to a voltage level obtained by dividing the clamp voltage V_{clamp} at the same voltage division ratio as the voltage division ratio by the resistance elements 23 and 24. That is, an output signal of the comparator 56 indicates a comparison result between the level of the rectified voltage |V_{AC}| and the level of the clamp voltage V_{clamp}. The CPU 52 determines the on timing and the off timing of the switch 13 based on the output signal of the comparator 56.

FIG. 2D is a circuit block diagram showing another example of the configuration of the control circuit 15. The control circuit 15 may include a PWM circuit 55 in place of the I/O circuit 54 shown in FIG. 2C. The PWM circuit 55 outputs the control signal V_{cnt} that is a pulse signal having a predetermined pulse width based on the command from the CPU 52.

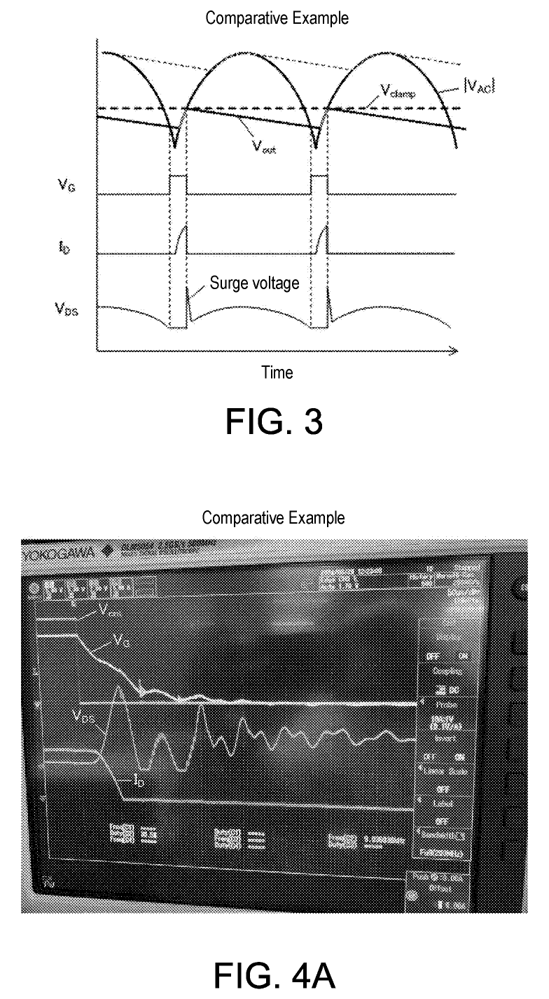

Here, FIG. 3 is a timing chart showing an example of operation of an AC/DC conversion circuit according to a comparative example. The AC/DC conversion circuit according to the comparative example differs from the switch control according to an embodiment of the disclosure in the mode of switch control performed by the control circuit 15.

The control circuit 15 according to the comparative example controls the driver 14 so that the switch 13 transitions to an on state in response to the level of the rectified voltage |V_{AC}| becoming lower than the level of the output voltage Vₒᵤₜ, and the switch 13 transitions to an off state in response to the level of the rectified voltage |V_{AC}| becoming higher than the level of the clamp voltage V_{clamp}.

The driver 14 generates the drive signal V_{G} based on control performed by the control circuit 15 and supplies the drive signal V_{G} to the switch 13. The switch 13 operates according to the drive signal V_{G} to transition to an on state in response to the level of the rectified voltage |V_{AC}| becoming lower than the level of the output voltage Vₒᵤₜ, and to transition to an off state in response to the level of the rectified voltage |V_{AC}| becoming higher than the level of the clamp voltage V_{clamp}. Accordingly, transition of the switch 13 to an on state (turn on) and transition to an off state (turn off) are performed within a period in which the level of the rectified voltage |V_{AC}| is rising. Hereinafter, this control mode is referred to as "rising clamp". According to the rising clamp, a surge voltage is generated in a drain-source voltage V_{DS} because a drain current I_{D} changes rapidly during transition of the switch 13 to an off state.

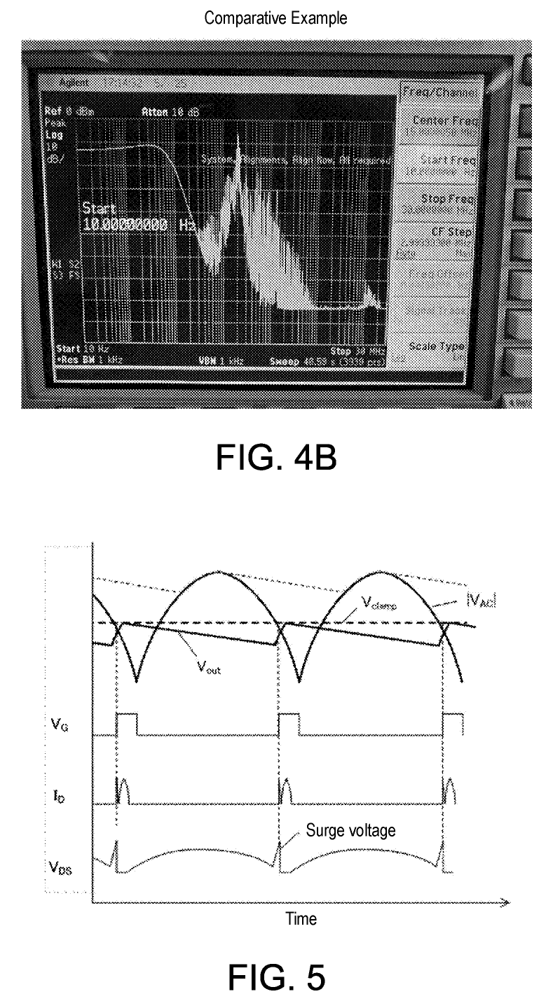

FIG. 4A shows measured waveforms of the control voltage V_{cnt}, the drive voltage V_{G}, the drain current I_{D}, and the drain-source voltage V_{DS} in the case of performing switch control according to the comparative example. FIG. 4A shows a state in which a surge voltage is generated in the drain-source voltage V_{DS} because the drain current I_{D} changes rapidly during transition of the switch 13 to an off state.

FIG. 4B is a diagram showing analysis results of a frequency spectrum of the drain-source voltage V_{DS} in the case of performing switch control according to the comparative example. It was confirmed that in the frequency spectrum of the drain-source voltage V_{DS}, a significant peak occurs around 20 kHz. This is caused by the surge voltage and may become conducted interference waves, so it is preferable to suppress this.

On the other hand, FIG. 5 is a timing chart showing an example of operation of the AC/DC conversion circuit 10 according to an embodiment of the disclosure. FIG. 5 shows waveforms of the rectified voltage |V_{AC}|, the clamp voltage V_{clamp}, the output voltage Vₒᵤₜ, the drive voltage V_{G}, the drain current I_{D}, and the drain-source voltage V_{DS}.

The rectifier circuit 11 performs, for example, full-wave rectification of an AC voltage input via a commercial power outlet and outputs the rectified voltage |V_{AC}|.

The control circuit 15 controls the driver 14 so that the switch 13 transitions to an on state in response to the level of the rectified voltage |V_{AC}| becoming lower than the level of the clamp voltage V_{clamp}, and the switch 13 transitions to an off state before the level of the rectified voltage |V_{AC}| becomes higher than the level of the clamp voltage V_{clamp}.

The driver 14 generates the drive signal V_{G} based on control performed by the control circuit 15 and supplies the drive signal V_{G} to the switch 13.

The switch 13 operates according to the drive signal V_{G} to transition to an on state in response to the level of the rectified voltage |V_{AC}| becoming lower than the level of the clamp voltage V_{clamp}, and to transition to an off state before the level of the rectified voltage |V_{AC}| becomes higher than the level of the clamp voltage V_{clamp}. Accordingly, transition of the switch 13 to an on state (turn on) and transition to an off state (turn off) are performed within a period in which the level of the rectified voltage |V_{AC}| is falling.

In response to the switch 13 entering an on state, the drain current I_{D} flows, thereby charging the capacitor 16 and causing the level of the output voltage Vₒᵤₜ to rise. In response to the switch 13 entering an off state, the capacitor 16 is discharged by the load 40, and the level of the output voltage Vₒᵤₜ falls. In response to the switch 13 intermittently entering an on state, the level of the output voltage Vₒᵤₜ is suppressed to the level of the clamp voltage V_{clamp} which is lower than the level along the peak of the rectified voltage |V_{AC}| (indicated by the broken line in FIG. 5). A surge voltage is generated in the drain-source voltage V_{DS} because the drain current I_{D} changes rapidly during transition of the switch 13 to an on state.

According to the switch control of the first embodiment of the disclosure (see FIG. 5), transition of the switch 13 to an on state (turn on) and transition to an off state (turn off) are performed within a period in which the level of the rectified voltage |V_{AC}| is falling. Hereinafter, this control mode is referred to as "falling clamp". According to the falling clamp, since the level of the rectified voltage |V_{AC}| is falling at the timing when the switch 13 transitions to an off state, the drain current I_{D} drops gradually. Therefore, no surge voltage is generated during transition of the switch 13 to an off state. On the other hand, although a surge voltage is generated due to the rapid change in drain current I_{D} during transition of the switch 13 to an on state, the change in drain current I_{D} within the period in which the level of the rectified voltage |V_{AC}| is falling is suppressed by the inductance (pillar transformer) of the power line for supplying an AC voltage from the AC power supply 30. That is, according to the switch control of the embodiment of the disclosure, the change in current during transition of the switch 13 to an on state and during transition to an off state becomes gradual, compared to the switch control according to the comparative example (rising clamp, see FIG. 4). This makes it possible to suppress the surge voltage generated in association with the switching of the switch 13, and makes it possible to suppress conducted interference waves. Further, according to the AC/DC conversion circuit 10 of the present embodiment, the means for suppressing conducted interference waves is realized by software, making it possible to flexibly perform adjustment for optimization.

### Second Embodiment

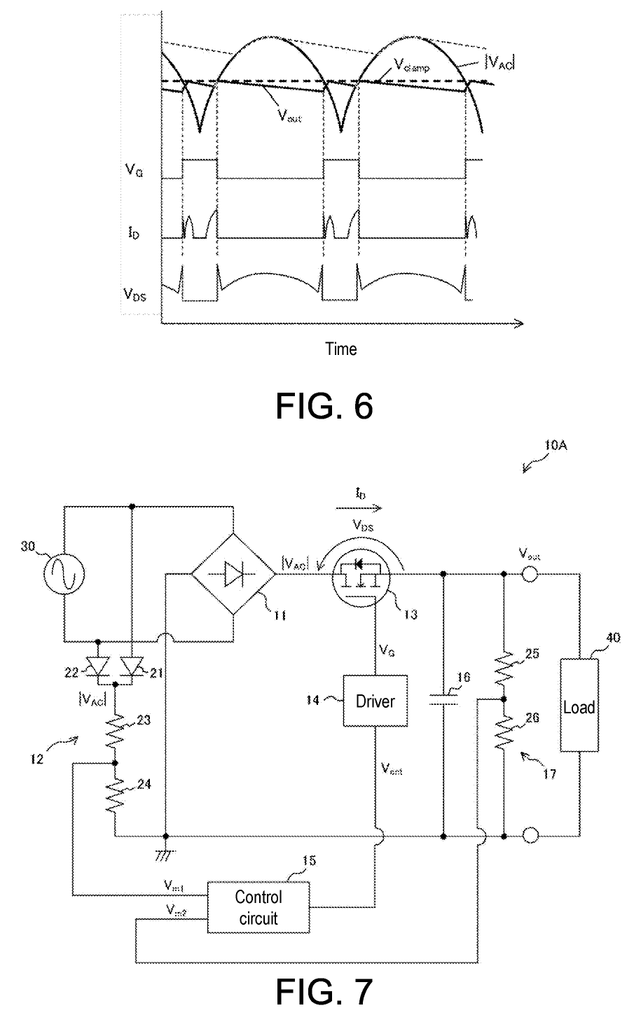

FIG. 6 is a timing chart showing an example of operation of an AC/DC conversion circuit 10 according to the second embodiment of the disclosure. The AC/DC conversion circuit 10 according to the second embodiment differs from the switch control according to the first embodiment described above in the mode of switch control performed by the control circuit 15.

The control circuit 15 according to the second embodiment controls the driver 14 so that the switch 13 transitions to an on state in response to the level of the rectified voltage |V_{AC}| becoming lower than the level of the clamp voltage V_{clamp}, and the switch 13 transitions to an off state in response to the level of the rectified voltage |V_{AC}| becoming higher than the level of the clamp voltage V_{clamp}.

The driver 14 generates the drive signal V_{G} according to control performed by the control circuit 15 and supplies the drive signal V_{G} to the switch 13. The switch 13, according to the drive signal V_{G}, transitions to an on state in response to the level of the rectified voltage |V_{AC}| becoming lower than the level of the clamp voltage V_{clamp}, and transitions to an off state in response to the level of the rectified voltage |V_{AC}| becoming higher than the level of the clamp voltage V_{clamp}. Accordingly, transition of the switch 13 to an on state (turn on) is performed within a period in which the level of the rectified voltage |V_{AC}| is falling, and transition of the switch 13 to an off state (turn off) is performed within a period in which the level of the rectified voltage |V_{AC}| is rising.

With a timing at which the level of the rectified voltage |V_{AC}| becomes minimum (zero) within the period from transition of the switch 13 to an on state until transition to an off state, it is possible to suppress the rise of the output voltage Vₒᵤₜ that occurs when the switch 13 transitions to an on state. That is, according to the AC/DC conversion circuit 10 of the second embodiment of the disclosure, it becomes possible to suppress ripples occurring in the output voltage Vₒᵤₜ. Alternatively, in the case of ripple suppression not being required, the capacitance of the smoothing capacitor 16 can be reduced, thereby making it possible to achieve miniaturization of the device. Further, by reducing the capacitance of the smoothing capacitor 16, the ESR (Equivalent Series Resistance) becomes smaller, making it possible to reduce loss. Furthermore, according to the control mode of the present embodiment, the current can be divided to reduce the peak value of current, so it becomes possible to suppress conducted interference waves.

### Third Embodiment

FIG. 7 is a diagram showing an example of the configuration of an AC/DC conversion circuit 10A according to the third embodiment of the disclosure. The AC/DC conversion circuit 10A differs from the AC/DC conversion circuit 10 according to the first embodiment described above (see FIG. 1) in that the AC/DC conversion circuit 10A includes an output voltage monitor circuit 17.

The output voltage monitor circuit 17 is a circuit for monitoring the output voltage Vₒᵤₜ. The output voltage monitor circuit 17 includes resistance elements 25 and 26 that are connected in parallel to the capacitor 16. The output voltage monitor circuit 17 outputs a monitor voltage Vₘ₂ obtained by dividing the output voltage Vₒᵤₜ from a connection point of the resistance element 25 and the resistance element 26. The monitor voltage Vₘ₂ is supplied to the control circuit 15. The control circuit 15 outputs the control signal V_{cnt} for controlling the driver 14 based on the monitor voltages Vₘ₁ and Vₘ₂.

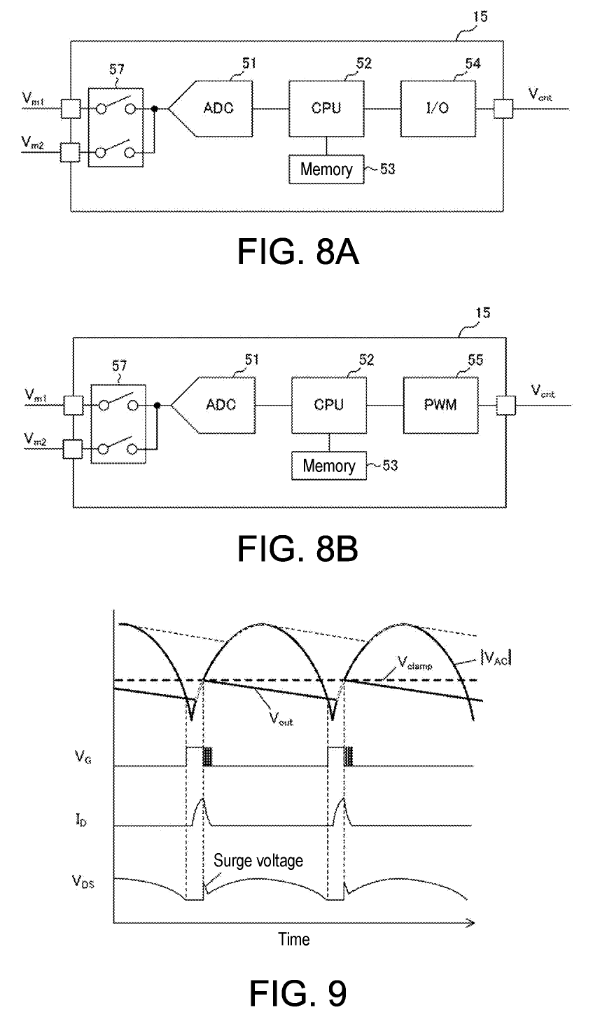

FIG. 8A and FIG. 8B are circuit block diagrams each showing an example of the configuration of the control circuit 15 according to the third embodiment. The control circuit 15 according to the third embodiment includes a selector 57 for selectively inputting the monitor voltage Vₘ₁ indicating the level of the rectified voltage |V_{AC}| and the monitor voltage Vₘ₂ indicating the level of the output voltage Vₒᵤₜ to the analog-to-digital converter 51. The other components of the control circuit 15 are the same as those of the control circuit 15 according to the first embodiment described above, so description thereof is omitted.

FIG. 9 is a timing chart showing an example of operation of the AC/DC conversion circuit 10A according to the third embodiment. The control circuit 15 controls the driver 14 so that the switch 13 transitions to an on state in response to the level of the rectified voltage |V_{AC}| becoming lower than the level of the output voltage Vₒᵤₜ, and the switch transitions to an off state in response to the level of the rectified voltage |V_{AC}| becoming higher than the level of the clamp voltage V_{clamp}. The control circuit 15 further controls the driver 14 so that short-term on states of the switch 13 occur continuously multiple times immediately after transition of the switch 13 to an off state. The short term refers to a period sufficiently shorter than the on period of the switch 13 immediately before the continuous on states occurring multiple times. The on-off timing of the switch 13 according to the present embodiment can be appropriately set by a program of the control circuit 15.

The driver 14 generates the drive signal V_{G} according to control performed by the control circuit 15 and supplies the drive signal V_{G} to the switch 13. The switch 13 operates according to the drive signal V_{G} to transition to an on state in response to the level of the rectified voltage |V_{AC}| becoming lower than the level of the output voltage Vₒᵤₜ, and to transition to an off state in response to the level of the rectified voltage |V_{AC}| becoming higher than the level of the clamp voltage V_{clamp}. The switch 13 further operates so that short-term on states occur continuously multiple times immediately after transition to an off state.

According to the switch control of the comparative example described above (see FIG. 3), a surge voltage is generated in the drain-source voltage V_{DS} because the drain current I_{D} changes rapidly during transition of the switch 13 to an off state. On the other hand, according to the switch control of the present embodiment, the switch 13 operates so that short-term on states occur continuously multiple times immediately after transition to an off state. Accordingly, the change in drain current I_{D} during transition of the switch 13 to an off state becomes gradual, and the surge voltage is suppressed.

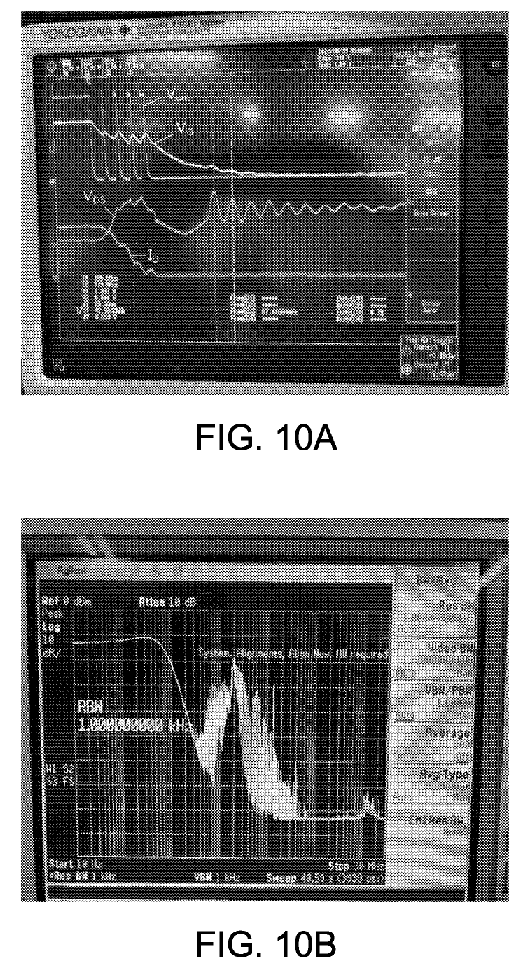

FIG. 10A shows measured waveforms of the control signal V_{cnt}, the drive voltage V_{G}, the drain current I_{D}, and the drain-source voltage V_{DS} in the case of performing switch control according to the third embodiment. Compared to the measured waveforms according to the comparative example shown in FIG. 5A, the change in drain current I_{D} during transition of the switch 13 to an off state is gradual, and the surge voltage is suppressed.

FIG. 10B is a diagram showing analysis results of the frequency spectrum of the drain-source voltage V_{DS} in the case of performing switch control according to the third embodiment. Compared to the frequency spectrum according to the comparative example shown in FIG. 5B, the peak around 20 kHz that occurs due to the surge voltage is suppressed. That is, conducted interference waves are suppressed.

Further, according to the AC/DC conversion circuit 10A of the present embodiment, the means for suppressing conducted interference voltage is realized by software, making it possible to flexibly perform adjustment for optimization.

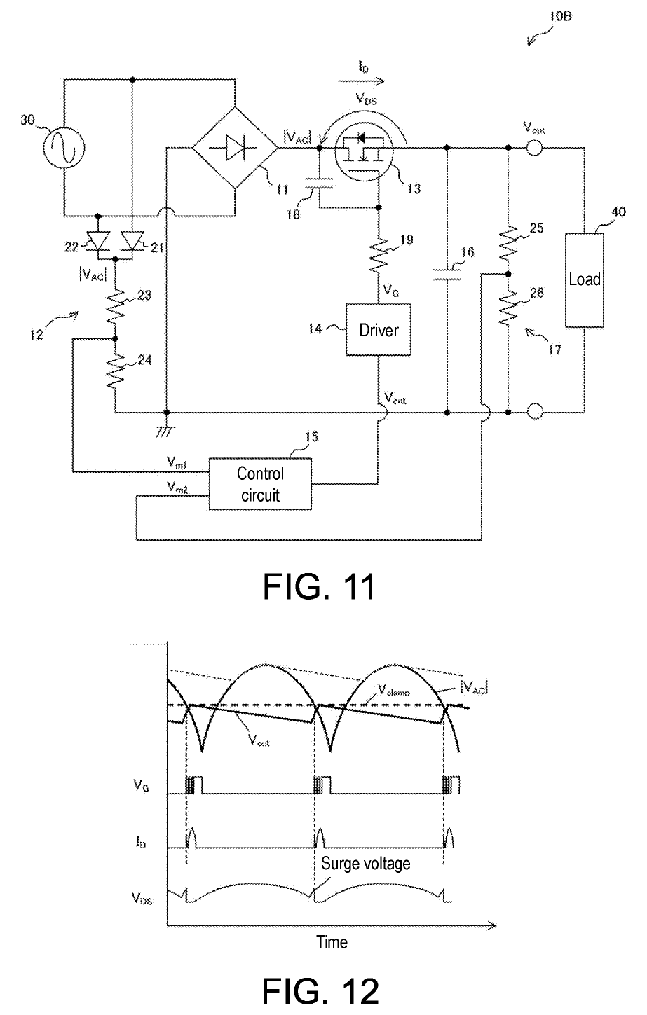

FIG. 11 is a diagram showing an example of the configuration of an AC/DC conversion circuit 10B according to a modification example. The AC/DC conversion circuit 10B differs from the AC/DC conversion circuit 10A shown in FIG. 7 in that the AC/DC conversion circuit 10B includes a capacitor 18 and a resistance element 19. The capacitor 18 is provided between the gate and source of the MOSFET that constitutes the switch 13. The resistance element 19 is provided between the gate of the MOSFET constituting the switch 13 and the driver 14. By connecting the capacitor 18 and the resistance element 19 to the MOSFET, the change in drain current I_{D} during transition of the switch 13 to an off state can be made more gradual. This makes it possible to enhance the effect of suppressing conducted interference waves.

### Fourth Embodiment

FIG. 12 is a timing chart showing an example of operation of an AC/DC conversion circuit 10 according to the fourth embodiment of the disclosure. The AC/DC conversion circuit 10 according to the fourth embodiment differs from the switch control according to the first embodiment in the mode of switch control performed by the control circuit 15.

The control circuit 15 according to the fourth embodiment controls the driver 14 so that the switch 13 transitions to an on state in response to the level of the rectified voltage |V_{AC}| becoming lower than the level of the clamp voltage V_{clamp}, and the switch 13 transitions to an off state before the level of the rectified voltage |V_{AC}| becomes higher than the level of the clamp voltage V_{clamp}. The control circuit 15 further controls the driver 14 so that short-term on states of the switch 13 occur continuously multiple times immediately before transition of the switch 13 to an on state. The short term refers to a period sufficiently shorter than the on period of the switch 13 immediately after the continuous on states occurring multiple times. The on-off timing of the switch 13 according to the present embodiment can be appropriately set by a program of the control circuit 15.

The driver 14 generates the drive signal V_{G} according to control performed by the control circuit 15 and supplies the drive signal V_{G} to the switch 13. The switch 13 operates according to the drive signal V_{G} to transition to an on state in response to the level of the rectified voltage |V_{AC}| becoming lower than the level of the clamp voltage V_{clamp}, and to transition to an off state before the level of the rectified voltage |V_{AC}| becomes higher than the level of the clamp voltage V_{clamp}. The switch 13 further operates so that short-term on states occur continuously multiple times immediately before transition to an on state.

According to the switch control of the first embodiment described above (see FIG. 5), a surge voltage is generated in the drain-source voltage V_{DS} because the drain current I_{D} changes rapidly during transition of the switch 13 to an on state. On the other hand, according to the switch control of the present embodiment, the switch 13 operates so that short-term on states occur continuously multiple times immediately before transition to an on state. Accordingly, the change in drain current I_{D} during transition of the switch 13 to an on state becomes gradual, and the surge voltage is suppressed. As a result, it is possible to further suppress conducted interference waves.

It is noted that following the example of the AC/DC conversion circuit 10B shown in FIG. 11, a capacitor may be provided between the gate and source of the MOSFET that constitutes the switch 13, and a resistance element may be provided between the gate of the MOSFET constituting the switch 13 and the driver 14. This makes it possible to enhance the effect of suppressing conducted interference waves.

### Fifth Embodiment

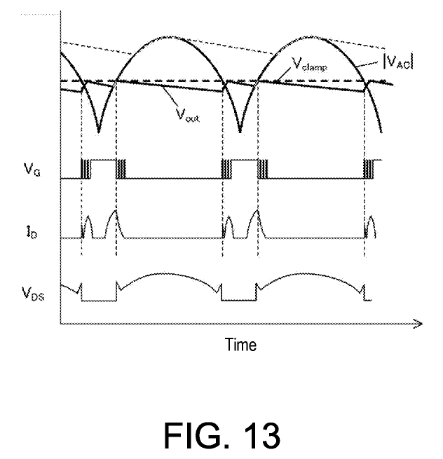

FIG. 13 is a timing chart showing an example of operation of an AC/DC conversion circuit 10 according to the fifth embodiment of the disclosure. The AC/DC conversion circuit 10 according to the fifth embodiment differs from the switch control according to the first embodiment in the mode of switch control performed by the control circuit 15.

The control circuit 15 according to the fifth embodiment controls the driver 14 so that the switch 13 transitions to an on state in response to the level of the rectified voltage |V_{AC}| becoming lower than the level of the clamp voltage V_{clamp}, and the switch 13 transitions to an off state in response to the level of the rectified voltage |V_{AC}| becoming higher than the level of the clamp voltage V_{clamp}. The control circuit 15 further controls the driver 14 so that short-term on states of the switch 13 occur continuously multiple times immediately before transition of the switch 13 to an on state, and short-term on states of the switch 13 occur continuously multiple times immediately after transition of the switch 13 to an off state. The short term refers to a period sufficiently shorter than the on period of the switch 13 before and after the continuous on states occurring multiple times. The on-off timing of the switch 13 according to the present embodiment can be appropriately set by a program of the control circuit 15.

The driver 14 generates the drive signal V_{G} according to control performed by the control circuit 15 and supplies the drive signal V_{G} to the switch 13. The switch 13 operates according to the drive signal V_{G} to transition to an on state in response to the level of the rectified voltage |V_{AC}| becoming lower than the level of the clamp voltage V_{clamp}, and to transition to an off state in response to the level of the rectified voltage |V_{AC}| becoming higher than the level of the clamp voltage V_{clamp}. The switch 13 further operates so that short-term on states occur continuously multiple times immediately before transition to an on state, and short-term on states occur continuously multiple times immediately after transition to an off state.

According to the switch control of the second embodiment described above (see FIG. 6), a surge voltage is generated in the drain-source voltage V_{DS} because the drain current I_{D} changes rapidly during transition of the switch 13 to an on state and during transition to an off state, respectively. On the other hand, according to the switch control of the present embodiment, the switch 13 operates so that short-term on states occur continuously multiple times immediately before transition to an on state and immediately after transition to an off state, respectively. Accordingly, the change in drain current I_{D} during transition of the switch 13 to an on state and during transition to an off state becomes gradual, and the surge voltage is suppressed. This makes it possible to suppress conducted interference waves.

Furthermore, according to the switch control of the present embodiment, with a timing at which the level of the rectified voltage |V_{AC}| becomes minimum (zero) within the period from transition of the switch 13 to an on state until transition to an off state, it is possible to suppress the rise of the output voltage Vₒᵤₜ that occurs when the switch 13 transitions to an on state. That is, according to the AC/DC conversion circuit 10 of the present embodiment, it becomes possible to suppress ripples occurring in the output voltage Vₒᵤₜ.

It is noted that following the example of the AC/DC conversion circuit 10B shown in FIG. 11, a capacitor may be provided between the gate and source of the MOSFET that constitutes the switch 13, and a resistance element may be provided between the gate of the MOSFET constituting the switch 13 and the driver 14. This makes it possible to enhance the effect of suppressing conducted interference waves.

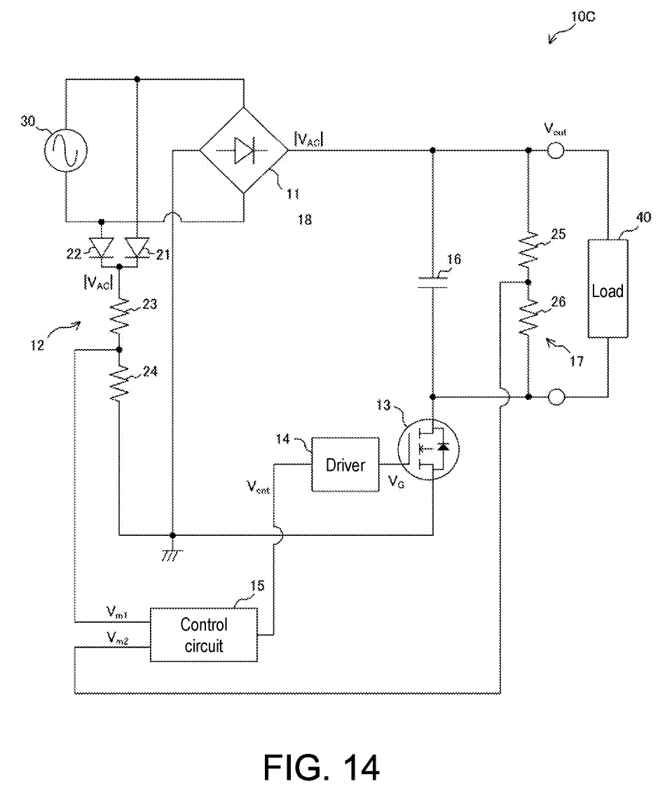

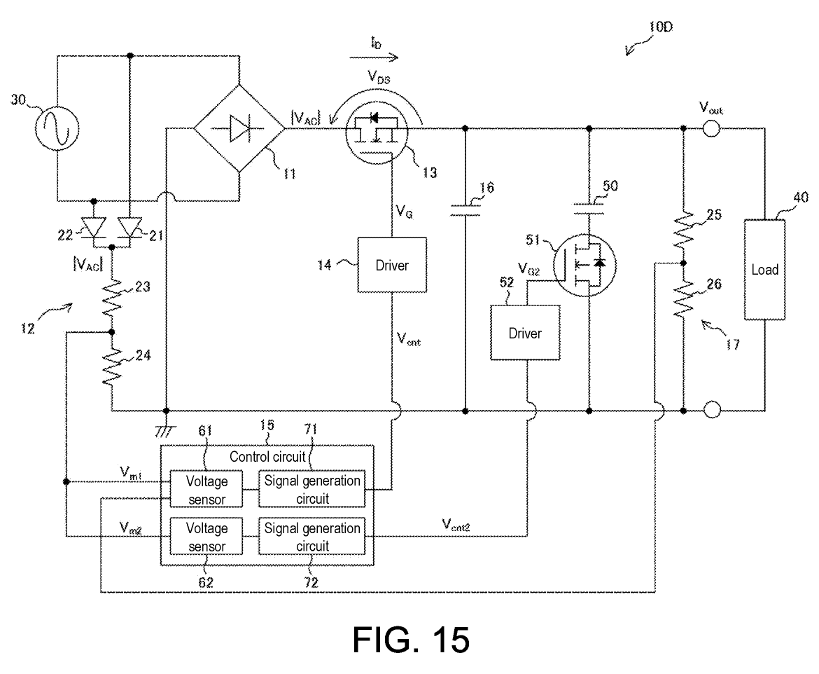

FIG. 14 is a diagram showing an example of the configuration of an AC/DC conversion circuit 10C according to a modification example. In the AC/DC conversion circuit 10C, the positional relationship between "switch 13" and "capacitor 16, output voltage monitor circuit 17, and load 40" is opposite to that in the AC/DC conversion circuits 10, 10A, and 10B according to the above embodiments. That is, while the switch 13 is provided on the high side in the AC/DC conversion circuits 10, 10A, and 10B, in the AC/DC conversion circuit 10B according to the modification example, the switch 13 is provided on the low side. The disclosure may also be applied to the AC/DC conversion circuit 10C having such a configuration.

### Sixth Embodiment

FIG. 15 is a diagram showing an example of the configuration of an AC/DC conversion circuit 10D according to the sixth embodiment of the disclosure. The AC/DC conversion circuit 10D differs from the AC/DC conversion circuit 10A according to the third embodiment described above (see FIG. 7) in that the AC/DC conversion circuit 10D includes a capacitor 50, a switch 51, and a driver 52.

The capacitor 50 has one end connected to the source of the MOSFET constituting the switch 13, and the other end connected to the drain of the MOSFET constituting the switch 51. The MOSFET that constitutes the switch 51 has a source connected to the ground line and a gate connected to the driver 52. The capacitor 50 is an example of the "second capacitor" in the disclosure.

The switch 51 turns on and off according to a drive signal V_{G2} supplied from the driver 52. In response to the switch 51 entering an on state, a parallel circuit of the capacitor 16 and the capacitor 50 is formed. Thereby, a composite capacitor including the capacitor 16 and the capacitor 50 is formed, which enhances the function of smoothing the rectified voltage |V_{AC}| output from the rectifier circuit 11. In response to the switch 51 entering an off state, the capacitor 50 is released from connection. The switch 51 is an example of the "second switch" in the disclosure.

The driver 52 outputs a drive signal V_{G2} for driving the switch 51 based on a control signal V_{cnt2}supplied from the control circuit 15. The drive signal V_{G2} is input to the gate of the MOSFET that constitutes the switch 51. The driver 52 is an example of the "second driver" in the disclosure. The drive signal V_{G2} is an example of the "second drive signal" in the disclosure.

The control circuit 15 outputs the control signal V_{cnt2} for controlling the driver 52 based on the monitor voltage Vₘ₁ indicating the level of the rectified voltage |V_{AC}|. More specifically, the control circuit 15 controls the driver 52 so that the switch 51 enters an on state in the case of the peak level of the rectified voltage |V_{AC}| being lower than the level of a threshold voltage, and the switch 51 enters an off state in the case of the peak level of the rectified voltage |V_{AC}| being higher than the level of the threshold voltage. The threshold voltage is a determination criterion for determining the peak level of the rectified voltage |V_{AC}| and is set in advance. In the control circuit 15 according to the present embodiment, a first system that generates the control signal V_{cnt} for controlling the driver 14 and a second system that generates the control signal V_{cnt2} for controlling the driver 52 are configured independently. Specifically, the driver circuit 15 has a first system including a voltage sensor 61 and a signal generation circuit 71, and a second system including a voltage sensor 62 and a signal generation circuit 72. The voltage sensor 61 detects the levels of the monitor voltages Vₘ₁ and Vₘ₂, and the signal generation circuit 71 outputs the control signal V_{cnt} based on the detection results of the voltage levels in the voltage sensor 61. This realizes a clamp operation of the output voltage Vₒᵤₜ similar to the first to fifth embodiments described above. The voltage sensor 62 detects the level of the monitor voltage Vₘ₁, and the signal generation circuit 72 outputs the control signal V_{cnt2} based on the detection result of the voltage level in the voltage sensor 62. This realizes a switching operation of the function for smoothing the rectified voltage |V_{AC}|.

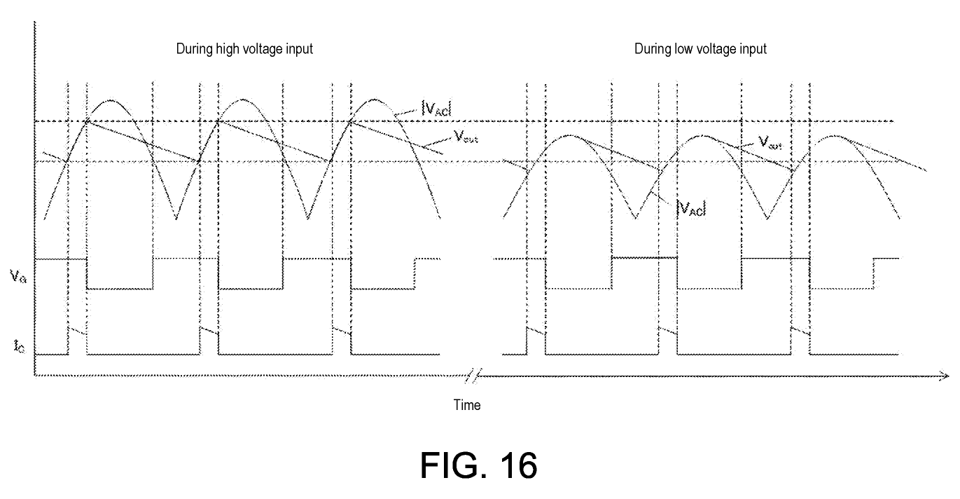

Here, FIG. 16 is a diagram showing an example of the operation waveform of the AC/DC conversion circuit 10A (see FIG. 7) according to the third embodiment of the disclosure in which the capacitor for smoothing the rectified voltage |V_{AC}| is configured by a single capacitor 16. FIG. 16 shows waveforms of the rectified voltage |V_{AC}|, the output voltage Vₒᵤₜ, the drive signal V_{G}, and the capacitor current I_{C}. The capacitor current I_{C} is a charging current of the capacitor 16. The left side of FIG. 16 shows waveforms in the case of the level of the AC voltage supplied from the AC power supply 30 being high (during high voltage input), and the right side of FIG. 16 shows waveforms in the case of the level of the AC voltage supplied from the AC power supply 30 being low (during low voltage input).

According to the AC/DC conversion circuit 10A of the third embodiment, the ripple range of the output voltage Vₒᵤₜ during low voltage input is significantly below the ripple range during high voltage input. To resolve this, it may be considered to increase the capacitance of the capacitor 16 that smooths the rectified voltage |V_{AC}|. However, in the case of increasing the capacitance of the capacitor 16, the capacitor current I_{C} becomes excessively large during high voltage input.

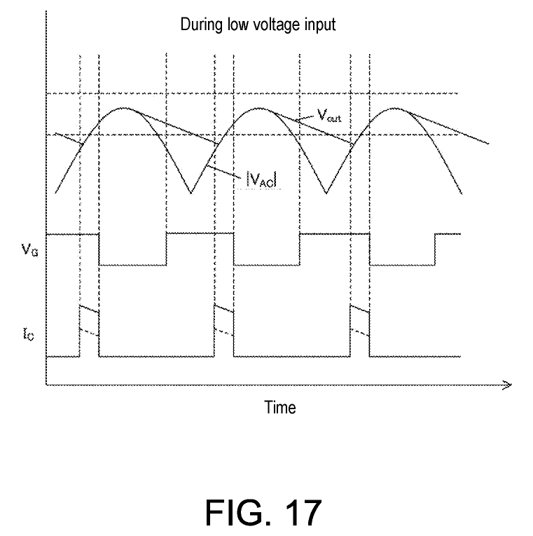

FIG. 17 is a diagram showing an example of the operation waveform of the AC/DC conversion circuit 10D according to the sixth embodiment of the disclosure. FIG. 17 shows waveforms of the rectified voltage |V_{AC}|, the output voltage Vₒᵤₜ, and the capacitor current I_{C}. In FIG. 17, waveforms of the output voltage Vₒᵤₜ and the capacitor current I_{C} in the AC/DC conversion circuit 10A (see FIG. 7) according to the third embodiment that does not include the capacitor 50 are indicated by dotted lines. The capacitor current I_{C} in the case of not including the capacitor 50 is a charging current of the capacitor 16, and the capacitor current I_{C} in the case of including the capacitor 50 is a charging current of a composite capacitor including the capacitor 16 and the capacitor 50.

The control circuit 15 sets the switch 51 to an on state in the case of the peak level of the rectified voltage |V_{AC}| being lower than the threshold voltage, that is, during low voltage input. This forms a parallel circuit of the capacitor 16 and the capacitor 50. This forms a composite capacitor including the capacitor 16 and the capacitor 50, and the capacitance becomes larger than the capacitor 16 alone. As a result, the capacitor current I_{C} becomes large, the function of smoothing the rectified voltage |V_{AC}| is enhanced, and it becomes possible to suppress a decrease in output voltage Vₒᵤₜ during low voltage input.

On the other hand, the control circuit 15 sets the switch 51 to an off state in the case of the peak level of the rectified voltage |V_{AC}| being higher than the threshold voltage, that is, during high voltage input. This releases the capacitor 50 from connection. This makes it possible to avoid an excessively large capacitor current I_{C} during high voltage input. It is noted that the control circuit 15 performs on-off control of the switch 13 in a mode similar to the control modes according to the first to fifth embodiments described above.

As described above, the AC/DC conversion circuit 10D according to the sixth embodiment of the disclosure includes the capacitor 50, the switch 51 that turns on and off according to the drive signal V_{G2} and forms a parallel circuit of the capacitor 16 and the capacitor 50 by entering an on state, and the driver 52 that outputs the drive signal V_{G2}. The control circuit 15 controls the driver 52 so that the switch 51 enters an on state in the case of the peak level of the rectified voltage |V_{AC}| being lower than a predetermined threshold voltage, and the switch 51 enters an off state in the case of the peak level of the rectified voltage |V_{AC}| being higher than the threshold voltage. This control is performed in parallel with the clamp operation of the output voltage Vₒᵤₜ according to the first to fifth embodiments described above. According to the AC/DC conversion circuit 10D of the present embodiment, it is possible to suppress a decrease in output voltage Vₒᵤₜ during low voltage input while avoiding an excessively large capacitor current I_{C} during high voltage input.

Regarding the above embodiments, the following supplementary notes are further disclosed.

### Supplementary Note 1

An AC/DC conversion circuit, comprising:

a rectifier circuit that performs full-wave rectification of an input AC voltage and outputs a rectified voltage;

a capacitor that smooths the rectified voltage;

a switch that turns on and off according to a drive signal, connects the rectifier circuit and the capacitor by entering an on state, and disconnects the rectifier circuit and the capacitor by entering an off state;

a driver that outputs the drive signal; and

a control circuit that controls the driver,

wherein the control circuit controls the driver so that the switch transitions to an on state in response to a level of the rectified voltage becoming lower than a level of a predetermined clamp voltage, and the switch transitions to an off state before the level of the rectified voltage becomes higher than the level of the clamp voltage.

### Supplementary Note 2

The AC/DC conversion circuit according to Supplementary Note 1, wherein the control circuit controls the driver so that short-term on states of the switch occur continuously multiple times immediately before transition of the switch to an on state.

### Supplementary Note 3

The AC/DC conversion circuit according to Supplementary Note 1, wherein the control circuit controls the driver so that the switch transitions to an on state in response to the level of the rectified voltage becoming lower than the level of the clamp voltage, and the switch transitions to an off state in response to the level of the rectified voltage becoming higher than the level of the clamp voltage.

### Supplementary Note 4

The AC/DC conversion circuit according to Supplementary Note 3, wherein the control circuit controls the driver so that short-term on states of the switch occur continuously multiple times immediately before transition of the switch to an on state, and short-term on states of the switch occur continuously multiple times immediately after transition of the switch to an off state.

### Supplementary Note 5

An AC/DC conversion circuit, comprising:

a rectifier circuit that performs full-wave rectification of an input AC voltage and outputs a rectified voltage;

a capacitor that smooths the rectified voltage;

a switch that turns on and off according to a drive signal, connects the rectifier circuit and the capacitor by entering an on state, and disconnects the rectifier circuit and the capacitor by entering an off state;

a driver that outputs the drive signal; and

a control circuit that controls the driver,

wherein the control circuit controls the driver so that the switch transitions to an on state in response to a level of the rectified voltage becoming lower than a level of an output voltage that is the rectified voltage smoothed by the capacitor, the switch transitions to an off state in response to the level of the rectified voltage becoming higher than a level of a predetermined clamp voltage, and short-term on states of the switch occur continuously multiple times immediately after transition of the switch to an off state.

### Supplementary Note 6

The AC/DC conversion circuit according to any one of Supplementary Notes 1 to 5, wherein the switch is an n-channel type MOSFET, and the AC/DC conversion circuit further comprises:

a capacitor that is provided between a gate and a source of the MOSFET; and

a resistance element that is provided between the gate of the MOSFET and the driver.

### Supplementary Note 7

The AC/DC conversion circuit according to any one of Supplementary Notes 1 to 6, wherein the control circuit controls the driver according to a program.

### Supplementary Note 8

The AC/DC conversion circuit according to any one of Supplementary Notes 1 to 7, further comprising:

a second capacitor;

a second switch that turns on and off according to a second drive signal and forms a parallel circuit of the capacitor and the second capacitor by entering an on state; and

a second driver that outputs the second drive signal,

wherein the control circuit controls the second driver so that the second switch enters an on state in a case of a peak level of the rectified voltage being lower than a predetermined threshold voltage, and the second switch enters an off state in a case of the peak level of the rectified voltage being higher than the threshold voltage.

### DESCRIPTION OF REFERENCE NUMERALS

10, 10A, 10B AC/DC conversion circuit, 11 rectifier circuit, 12 rectified voltage monitor circuit, 13 switch, 14 driver, 15 control circuit, 16 capacitor, 17 output voltage monitor circuit, 18 capacitor, 19 resistance element, 30 AC power supply, 40 load

What is claimed is:

1. An AC/DC conversion circuit, comprising:
a rectifier circuit that performs full-wave rectification of an input AC voltage and outputs a rectified voltage;
a capacitor that smooths the rectified voltage;
a switch that turns on and off according to a drive signal, connects the rectifier circuit and the capacitor by entering an on state, and disconnects the rectifier circuit and the capacitor by entering an off state;
a driver that outputs the drive signal; and
a control circuit that controls the driver,
wherein the control circuit controls the driver so that the switch transitions to an on state in response to a level of the rectified voltage becoming lower than a level of a predetermined clamp voltage, and the switch transitions to an off state before the level of the rectified voltage becomes higher than the level of the clamp voltage.

2. The AC/DC conversion circuit according to claim 1, wherein the control circuit controls the driver so that short-term on states of the switch occur continuously multiple times immediately before transition of the switch to an on state.

3. The AC/DC conversion circuit according to claim 1, wherein the control circuit controls the driver so that the switch transitions to an on state in response to the level of the rectified voltage becoming lower than the level of the clamp voltage, and the switch transitions to an off state in response to the level of the rectified voltage becoming higher than the level of the clamp voltage.

4. The AC/DC conversion circuit according to claim 3, wherein the control circuit controls the driver so that short-term on states of the switch occur continuously multiple times immediately before transition of the switch to an on state, and short-term on states of the switch occur continuously multiple times immediately after transition of the switch to an off state.

5. The AC/DC conversion circuit according to claim 1, wherein the switch is an n-channel type MOSFET, and the AC/DC conversion circuit further comprises:
a capacitor that is provided between a gate and a source of the MOSFET; and
a resistance element that is provided between the gate of the MOSFET and the driver.

6. The AC/DC conversion circuit according to claim 1, wherein the control circuit controls the driver according to a program.

7. The AC/DC conversion circuit according to claim 1, further comprising:
a second capacitor;
a second switch that turns on and off according to a second drive signal and forms a parallel circuit of the capacitor and the second capacitor by entering an on state; and
a second driver that outputs the second drive signal,
wherein the control circuit controls the second driver so that the second switch enters an on state in a case of a peak level of the rectified voltage being lower than a predetermined threshold voltage, and the second switch enters an off state in a case of the peak level of the rectified voltage being higher than the threshold voltage.

8. An AC/DC conversion circuit, comprising:
a rectifier circuit that performs full-wave rectification of an input AC voltage and outputs a rectified voltage;
a capacitor that smooths the rectified voltage;
a switch that turns on and off according to a drive signal, connects the rectifier circuit and the capacitor by entering an on state, and disconnects the rectifier circuit and the capacitor by entering an off state;
a driver that outputs the drive signal; and
a control circuit that controls the driver,
wherein the control circuit controls the driver so that the switch transitions to an on state in response to a level of the rectified voltage becoming lower than a level of an output voltage that is the rectified voltage smoothed by the capacitor, the switch transitions to an off state in response to the level of the rectified voltage becoming higher than a level of a predetermined clamp voltage, and short-term on states of the switch occur continuously multiple times immediately after transition of the switch to an off state.

9. The AC/DC conversion circuit according to claim 8, wherein the switch is an n-channel type MOSFET, and the AC/DC conversion circuit further comprises:
a capacitor that is provided between a gate and a source of the MOSFET; and
a resistance element that is provided between the gate of the MOSFET and the driver.

10. The AC/DC conversion circuit according to claim 8, wherein the control circuit controls the driver according to a program.

11. The AC/DC conversion circuit according to claim 8, further comprising:
a second capacitor;
a second switch that turns on and off according to a second drive signal and forms a parallel circuit of the capacitor and the second capacitor by entering an on state; and
a second driver that outputs the second drive signal,
wherein the control circuit controls the second driver so that the second switch enters an on state in a case of a peak level of the rectified voltage being lower than a predetermined threshold voltage, and the second switch enters an off state in a case of the peak level of the rectified voltage being higher than the threshold voltage.
